(19) United States
(12) Patent Application Publication
(10) Pub. No.: US 2014/0202988 A1
(43) Pub. Date: Jul. 24, 2014

(54) Process of etching an artificial leather

(71) Applicant: Tung-Hung Lu, Yilan (TW)

(72) Inventor: Tung-Hung Lu, Yilan (TW)

(21) Appl. No.: 13/746,325

(22) Filed: Jan. 22, 2013

(51) Int. Cl. B44C 1/22

(52) U.S. Cl. CPC B44C 1/227
USPC 216/83

(57) ABSTRACT

An artificial leather etching process is provided with mixing predetermined weight percentages of PU, PVC, PE, PET, and EVA to form a wet etching agent; rotating a pair of opposite rollers wherein a lower one of the rollers is partially submerged in the wet etching agent; moving a continuous artificial leather member through a joining line of the opposite rollers so that the wet etching agent adhered on the lower one of the rollers etches a bottom surface of the continuous artificial leather member into an uneven surface; and producing a finished continuous artificial leather when the continuous artificial leather member leaves the opposite rollers. The finished continuous artificial leather has a leather-like finish.

### BACKGROUND OF THE INVENTION

1. Field of the Invention

The invention relates to processes of artificial leather manufacture and more particularly to a process of etching an artificial leather with a wet etching agent to form an uneven surface thereon so that the finished artificial leather has a leather-like finish.

2. Description of Related Art

Leather is a durable and flexible material created by the tanning of animal rawhide and skin, often cattle hide. It can be produced through manufacturing processes ranging from cottage industry to heavy industry.

Some animal rights activists boycott the use of all items made from leather because they believe the practice of wearing animal hides to be unnecessary and cruel. Animal rights groups encourage the use of alternative materials such as artificial leather.

The present inventor is aware that the invention discussed below is neither taught nor rendered obvious by any patent disclosures.

### SUMMARY OF THE INVENTION

It is therefore one object of the invention to provide an artificial leather etching process comprising the steps of mixing a predetermined weight percentage of polyurethane (PU), a predetermined weight percentage of polyvinyl chloride (PVC), a predetermined weight percentage of polyethylene (PE), a predetermined weight percentage of polyethylene terephthalate (PET), and a predetermined weight percentage of ethylene-vinyl acetate (EVA) to form a wet etching agent; rotating a pair of opposite rollers wherein a lower one of the rollers is partially submerged in the wet etching agent; moving a continuous artificial leather member through a joining line of the opposite rollers so that the wet etching agent adhered on the lower one of the rollers etches a bottom surface of the continuous artificial leather member into an uneven surface; and producing a finished continuous artificial leather when the continuous artificial leather member leaves the opposite rollers.

The above and other objects, features and advantages of the invention will become apparent from the following detailed description taken with the accompanying drawings.

### BRIEF DESCRIPTION OF THE DRAWINGS

FIG. 1 schematically depicts a process of etching an artificial leather according to the invention;

FIG. 2 is a longitudinal sectional view of the finished continuous artificial leather member;

FIGS. 3, 4, 5 and 6 are perspective views each showing a portion of respective one of four finished continuous artificial leather members having different etched surfaces;

FIGS. 7, 8 and 9 are perspective views showing the finished continuous artificial leather member formed on a chair, a bag, and a pair of shoes respectively;

FIG. 10 is a perspective view of a portion of a finished continuous artificial leather member having through holes; and

FIG. 11 is a longitudinal sectional view of the finished continuous artificial leather member of FIG. 10.

### DETAILED DESCRIPTION OF THE INVENTION

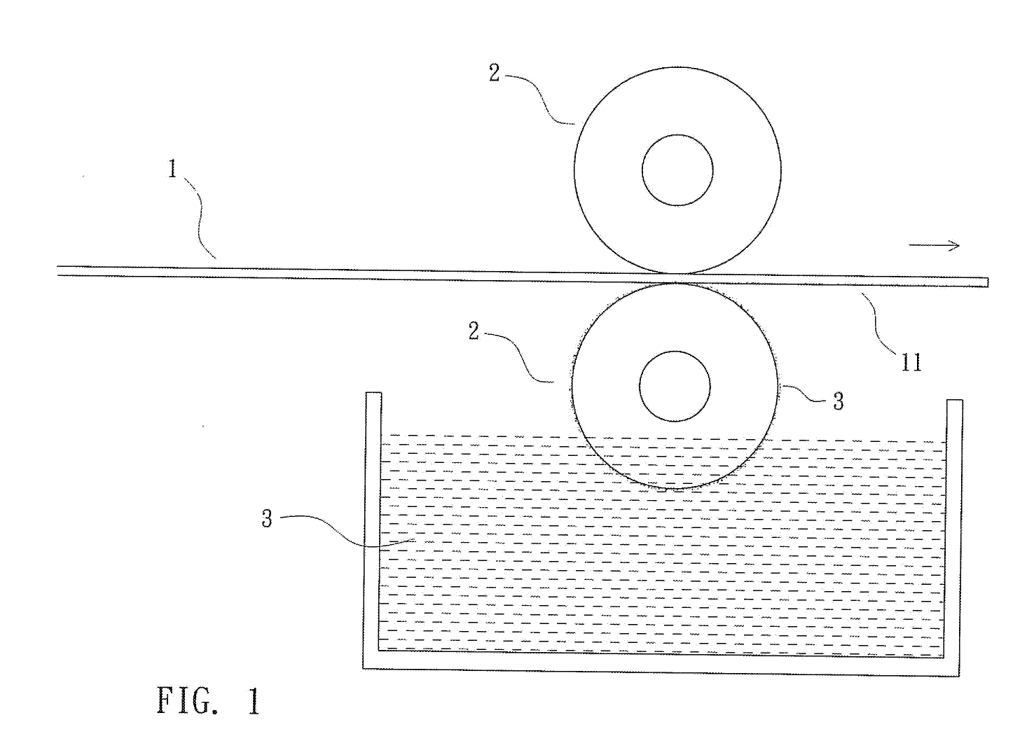

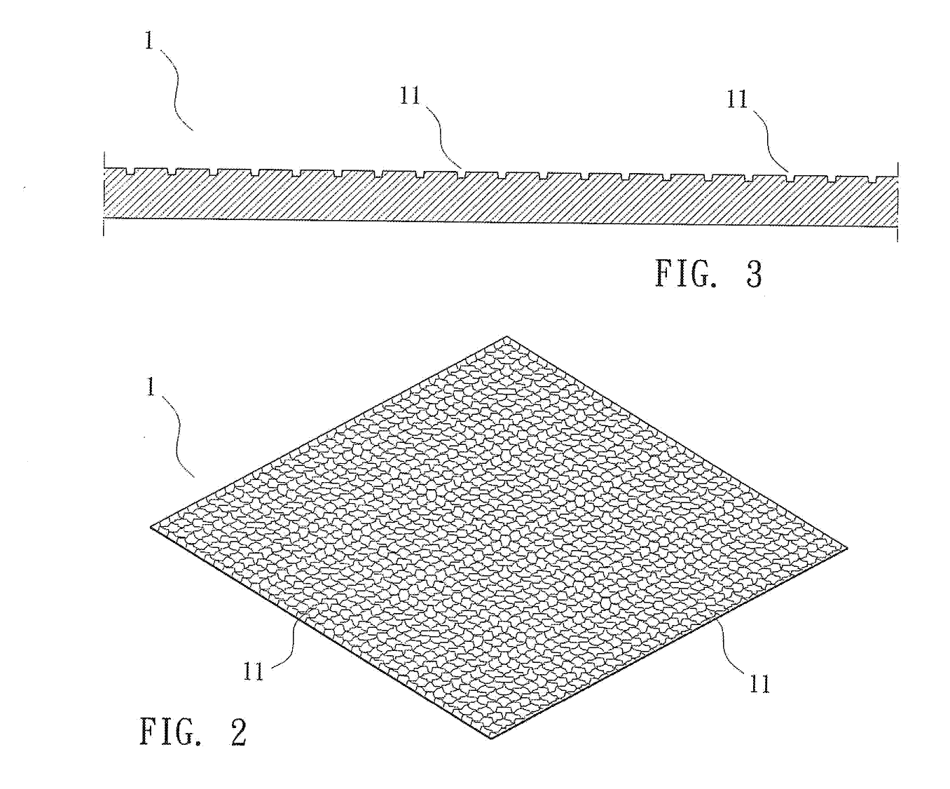

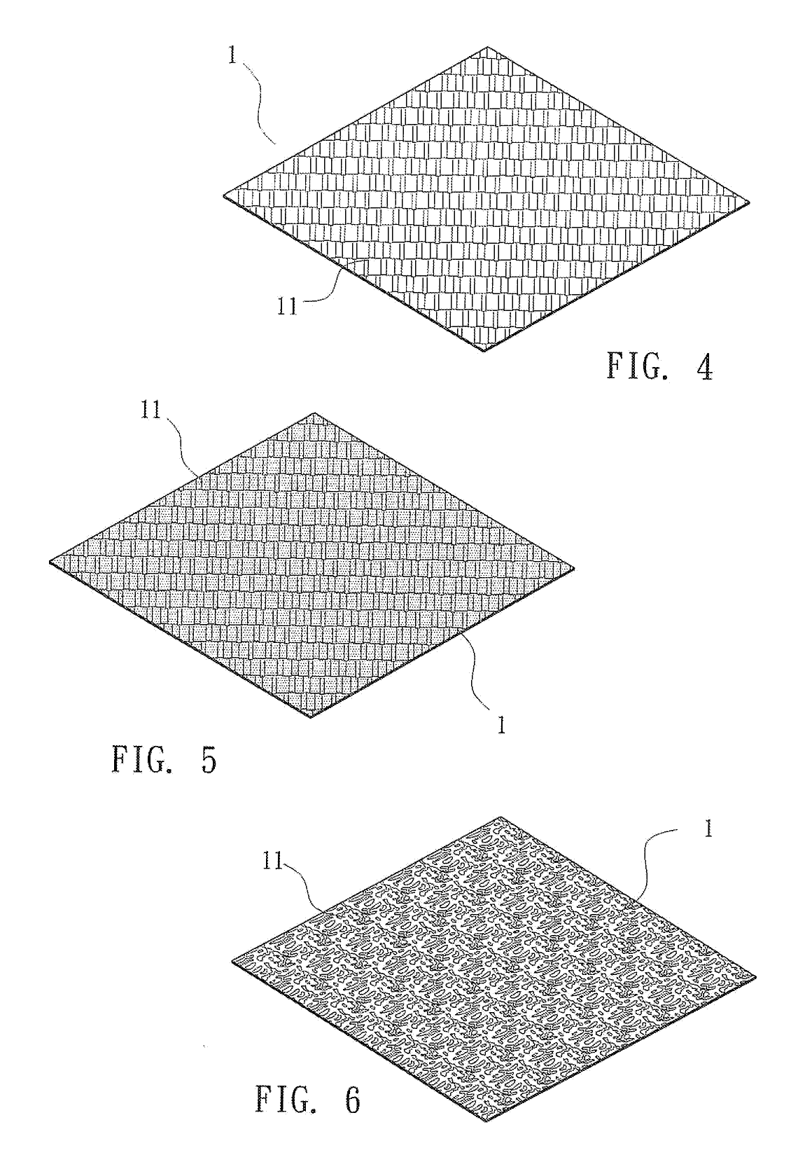

Referring to FIGS. 1 to 9, an etching process in accordance with the invention comprising the following steps as illustrated below.

A predetermined weight percentage of polyurethane (PU), a predetermined weight percentage of polyvinyl chloride (PVC), a predetermined weight percentage of polyethylene (PE), a predetermined weight percentage of polyethylene terephthalate (PET), and a predetermined weight percentage of ethylene-vinyl acetate (EVA) are mixed in a tank to form a wet etching agent 3.

A pair of opposite rollers 2 are rotated in which the lower roller 2 is partially submerged in the tank so that the wet etching agent 3 may adhere thereto, a continuous artificial leather member 1 further moves through a joining line of the rollers 2 so that the wet etching agent 3 may etch a bottom surface of the continuous artificial leather member 1, and an etched surface 11 is formed on the bottom surface of the continuous artificial leather member 1 so that a finished continuous artificial leather member 1 is produced. The finished continuous artificial leather member 1 is produced. The etched surface 11 makes the finished continuous artificial leather member 1 look like the real leather.

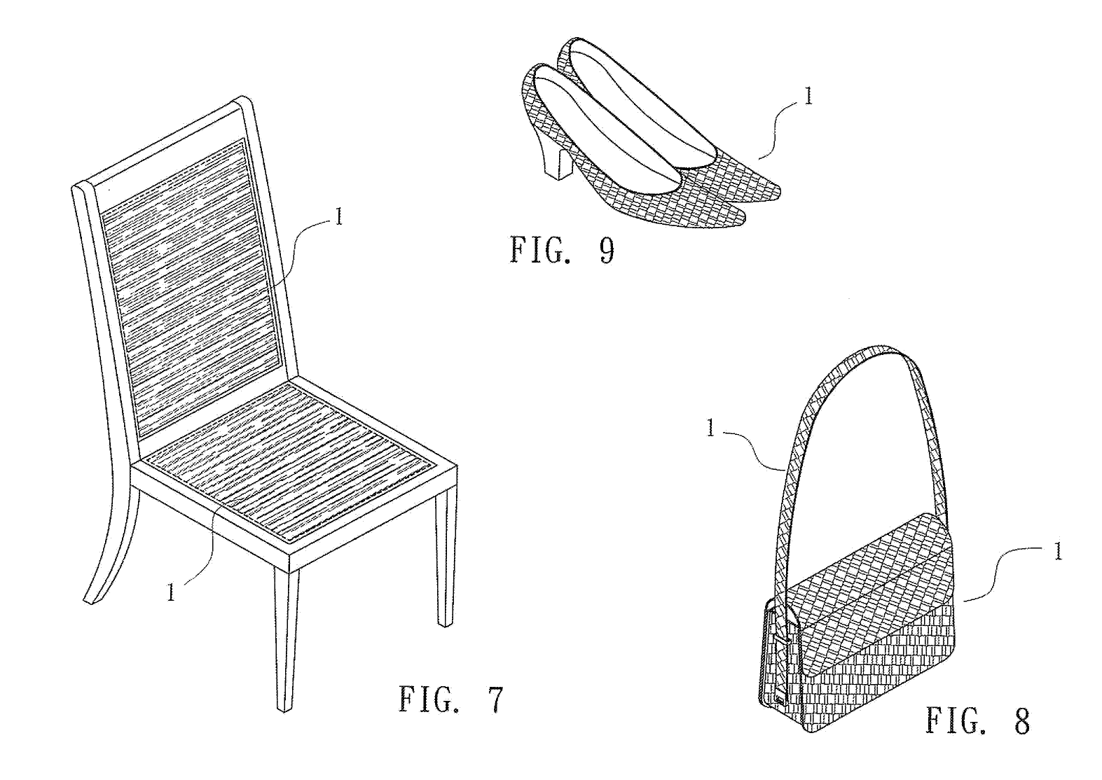

The etched surface 11 is comprised of a plurality of irregular grooves. In short, the etched surface 11 is uneven. As shown in FIGS. 3 to 6, a plurality of different patterns of the etched surface 11 are shown respectively. As shown in FIGS. 7 to 9, the finished continuous artificial leather member 1 can be employed as a material for manufacturing a chair, a bag, or a pair of shoes.

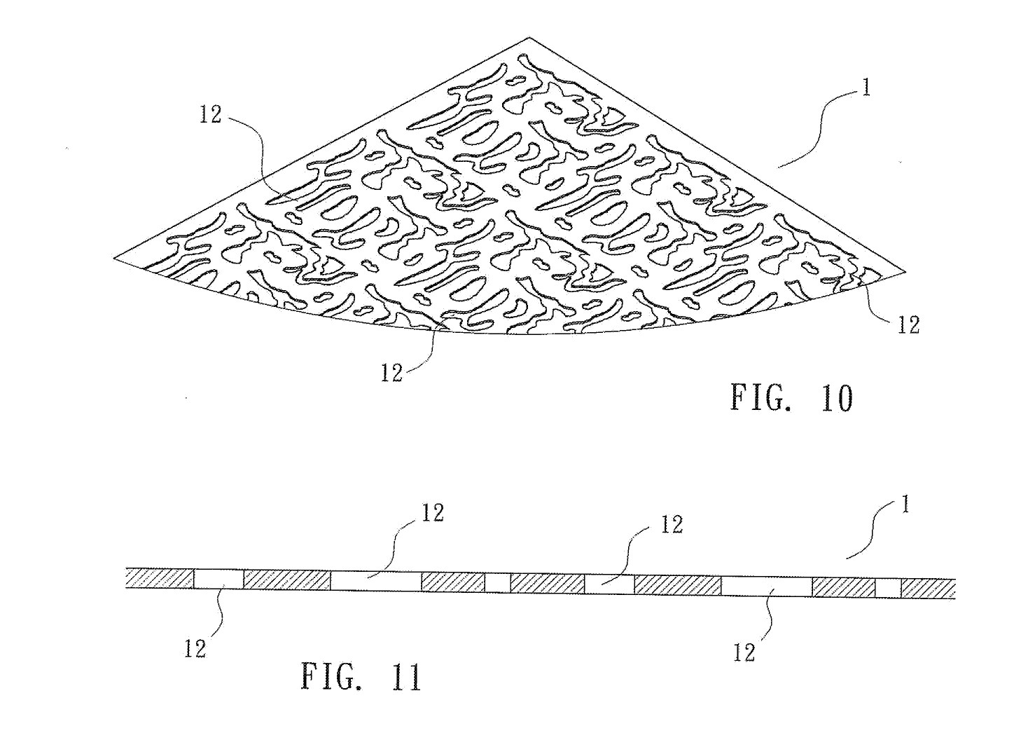

Referring to FIGS. 10 and 11, the continuous artificial leather member 1 may be formed with a plurality of irregular through holes 12 prior to the etching process.

While the invention has been described in terms of preferred embodiments, those skilled in the art will recognize that the invention can be practiced with modifications within the spirit and scope of the appended claims.

1. An artificial leather etching process comprising the steps of:
rotating a pair of opposite rollers wherein a lower one of the rollers is partially submerged in a wet etching agent including a predetermined weight percentage of polyurethane (PU), a predetermined weight percentage of polyvinyl chloride (PVC), a predetermined weight percentage of polyethylene (PE), a predetermined weight percentage of polyethylene terephthalate (PET), and a predetermined weight percentage of ethylene-vinyl acetate (EVA);
moving a continuous artificial leather member through a joining line of the opposite rollers so that the wet etching agent adhered on the lower one of the rollers etches a bottom surface of the continuous artificial leather member into an uneven surface; and
producing a finished continuous artificial leather when the continuous artificial leather member leaves the opposite rollers.
